(19) United States
(12) Patent Application Publication
(10) Pub. No.: US 2001/0037725 A1
(43) Pub. Date: Nov. 8, 2001

(54) Gas opening/closing pin

(76) Inventor: Sung Rong Jo, Kunsan-Si (KR)

Correspondence Address: McGuire Woods LLP, 1750 Tysons Boulevard, Suite 1800, Tysons Corner, McLean, VA, 22102-3915, US

(21) Appl. No.: 09/849,229

(22) Filed: May 7, 2001

(30) Foreign Application Priority Data
May 8, 2000 (KR) 2000-13019
Oct. 17, 2000 (KR) 2000-28898

(51) Int. Cl. F15B 11/08

(52) U.S. Cl. 91/418

(57) ABSTRACT

The present invention relates to a height regulating body which can be used in a table or a chair, and more particularly to a structure of a gas opening/closing pin for controlling the movement of a gas in a chamber of a spindle of a height regulating body. The present invention provides a gas opening/closing pin which opens and closes a gas inlet and outlet formed in a pipe holder which seals one end portion of a cylinder and moves the position of a piston in the cylinder, wherein at least one recess which opens the gas inlet and outlet is formed on the outer peripheral surface of the central portion of the gas opening/closing pin and one of a washer-shaped boss body and a diameter reducing portion in which the diameter is reduced is integrally formed. Even when the diameter reducing portion is formed at the upper portion of the gas opening/closing pin, since the lower end portion of the diameter reducing portion is caught by an annular jaw formed in the pipe holder, the assembling process is simple and the number of parts is reduced.

### BACKGROUND OF THE INVENTION

1. Field of the Invention

The present invention relates to a height regulating body which can be used in a table or a chair, and more particularly to a structure of a gas opening/closing pin for controlling the movement of a gas in a chamber of a spindle of a height regulating body.

2. Description of the Prior Art

Generally, in a height regulating body, as shown in FIG. 1, a spindle 50 is installed in a tube guide 55 installed in a cylindrical outer case 60. The spindle 50 includes a cylinder 30 into which the nitrogen gas is injected with a predetermined pressure, a piston 11 which divides the cylinder to a first chamber 30a and a second chamber 30b, and a pipe holder 70 which has a gas opening/closing pin 20 for flowing the gas in the first chamber 30a and the second chamber 30b.

The piston 11 is fixed to one end of a piston rod 10, and the other end of the piston rod 10 is fixed to one end of the cylindrical outer case 60 by using a fixing means 40.

Since the interior pressure of the cylinder 30 is higher than the atmospheric pressure, if a button 33 is pushed and a gas opening/closing pin 20 is opened so that the gas in the first chamber 30a and the second chamber 30b is moved through a gas inlet and outlet 16, the piston 11 is moved in the cylinder 30 by the pressure of the gas and the spindle 50 is moved along the inner surface of the tube guide 55 to regulate the height of the height regulating body.

The upward and downward movement of the spindle 50 along the inner surface of the tube guide 55 will be explained in detain with reference to FIGS. 2 and 3.

The pipe holder 70 has a cylindrical shape, and an operation hole 41 for receiving the gas opening/closing pin 20 is formed at the central portion of the pipe holder, and a plurality of O-rings are mounted to an O-ring recess 43 to seal the space between the pipe holder and the inner wall of the spindle 50. A space portion 46 for flowing the gas is formed at the central portion of the inner side of the pipe holder 70, and O-rings 45 are installed at both end portions of the space portion 46 to seal the space between the gas opening/closing pin 20 and the pipe holder 70. An inner side holder 47 is installed in the space portion 46 to maintain the interval of the O-rings 45 and to smoothly slide the opening/closing pin 20. A fine hole 47a is formed on one side of the inner side holder to connect the fine hole 47a to the gas inlet and outlet 16.

In the pipe holder having the above-mentioned structure, as shown in FIG. 2, when the gas opening/closing pin 20 is closed, the gas in the first chamber 30a is interrupted so that the gas can not be flowed through the gas inlet and outlet 16, the height of the spindle 50 is maintained.

In order to regulate the height of the spindle 50 by sliding the spindle 50, if the gas opening/closing pin 20 is pressed as shown in FIG. 3, the gas opening/closing pin is moved towards the first chamber 30a and the seal between the gas opening/closing pin 20 and the O-ring 45 is released to form a space. Namely, if the annular recess 48 formed at the central portion of the gas opening/closing pin is moved towards the O-ring 45, since the annular recess portion is smaller than the outer diameter of the gas opening/closing pin, a space is formed between the O-ring 45 and the gas opening/closing pin 20 and the gas of the first chamber 30a and the second chamber 30b is flowed through the opened gas inlet and outlet 16 and the gas pressure in the chamber is varied and the piston 11 is moved and the height of the spindle is regulated. After the height of the spindle is regulated, if the pressure applied to the button 33 is released, the gas inlet and outlet 16 is interrupted by the gas opening/closing pin 20.

In the height regulating body having the above-mentioned structure, the conventional gas opening/closing pin 20 has an annular recess 48 formed in the middle portion as shown in FIG. 4, and an inclined surface 58 is formed at the end portion of the annular recess. An insertion boss for inserting a fixing washer 200 is formed at the lower end portion of the gas opening/closing pin 20, and the fixing washer 200 is mounted to the insertion boss and the washer is fixed by a joint method.

Since the gas opening/closing pin 20 has an annular recess and the insertion boss is formed at the end portion of the gas opening/closing pin and jointed by using a separate washer, the manufacturing process is complex and the manufacturing cost is increased. The fixing washer is jointed to prevent the gas opening/closing pin 20 from being withdrawn by the interior of the cylinder.

### SUMMARY OF THE INVENTION

The present invention has been made to solve the above-mentioned problem, and accordingly it is an object of the present invention to provide a gas opening closing pin which can improve the assembling efficiency and reduce the manufacturing cost by forming a jaw on the upper side of a hole of a pipe holder and forming a diameter reducing portion caught by the jaw or by integrally forming a washer-shaped boss body at the lower end portion of the gas opening/closing pin.

In order to achieve the above-mentioned object, the present invention provides a gas opening/closing pin which opens and closes a gas inlet and outlet formed in a pipe holder which seals one end portion of a cylinder and moves the position of a piston in the cylinder, wherein at least one recess which opens the gas inlet and outlet is formed on the outer peripheral surface of the central portion of the gas opening/closing pin and one of a washer-shaped boss body and a diameter reducing portion in which the diameter is reduced is integrally formed.

The lower end portion of the diameter reducing portion of the gas opening/closing pin is caught by an annular jaw corresponding to the diameter reducing portion of the gas opening/closing pin and installed in the pipe holder.

The diameter reducing portion has at least one step.

The diameter reducing portion is tapered.

The gas opening/closing pin is made of a metal or a nonmetal.

The outer periphery of the upper end portion of the gas opening/closing pin is chamfered..

The recess formed on the outer peripheral surface of the central portion of the gas opening/closing pin is streamline-shaped.

The recess formed on the outer peripheral surface of the central portion of the gas opening/closing pin has an annular shape.

### BRIEF DESCRIPTION OF THE DRAWINGS

The above and other objects and advantages of the present invention will become readily apparent by reference to the following detailed description when considered in conjunction with the accompanying drawings wherein:

FIG. 1 is a cross-sectional view for showing a general gas cylinder type height regulating device;

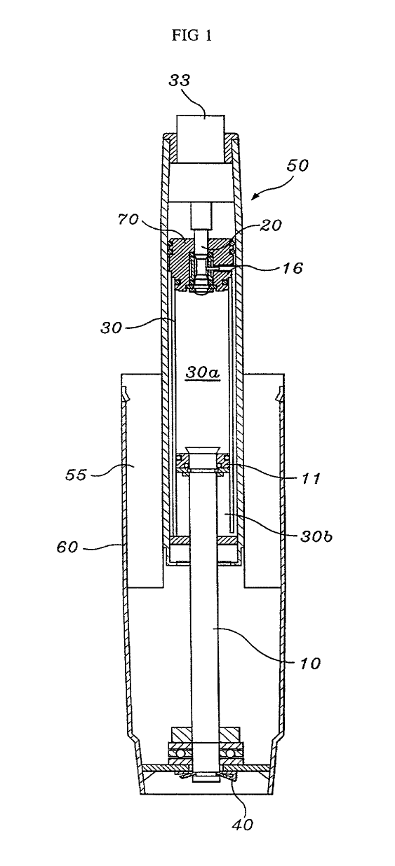

FIG. 2 is a cross-sectional view for showing the state in which a gas opening/closing pin having a conventional structure interrupts the gas inlet and outlet of a pipe holder;

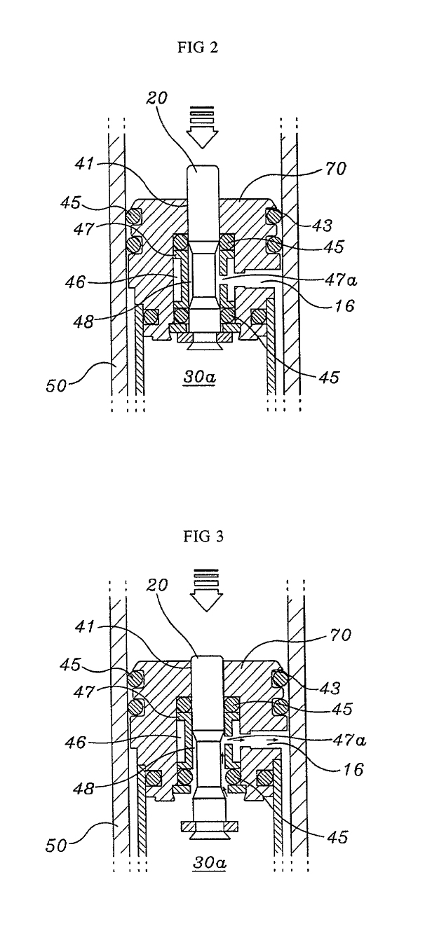

FIG. 3 is a cross-sectional view for showing the state in which the gas opening/closing pin having the conventional structure opens the gas inlet and outlet of the pipe holder;

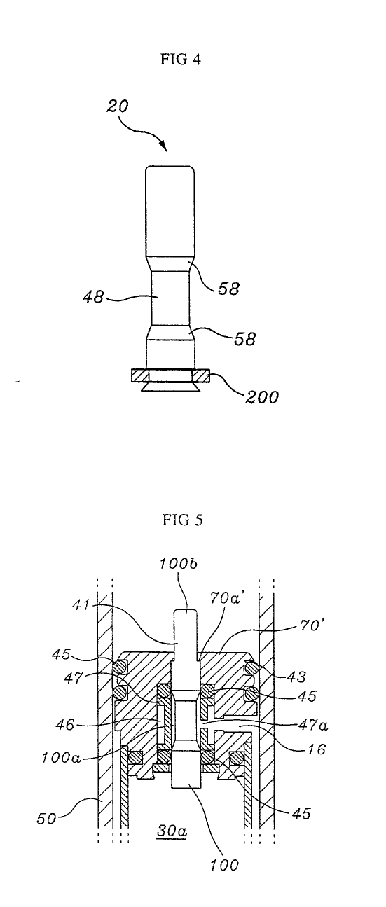

FIG. 4 is a cross-sectional view for showing a conventional gas opening/closing pin;

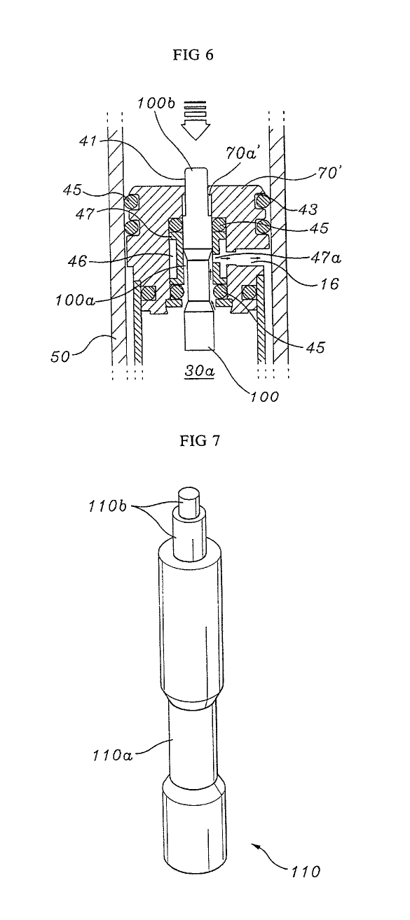

FIG. 5 is a cross-sectional view for showing the state in which a gas opening/closing pin according to the present invention interrupts a gas inlet and outlet of a pipe holder;

FIG. 6 is a cross-sectional view for showing the state in which the gas opening/closing pin according to the present invention opens the gas inlet and outlet of the pipe holder; and

FIGS. 7 to 13 is perspective views for showing various embodiments of a gas opening/closing pin according to the present invention.

### DETAILED DESCRIPTION OF THE PREFERRED EMBODIMENT

Hereinafter, preferred embodiments of the present invention will be explained in detail with reference to the attached drawings.

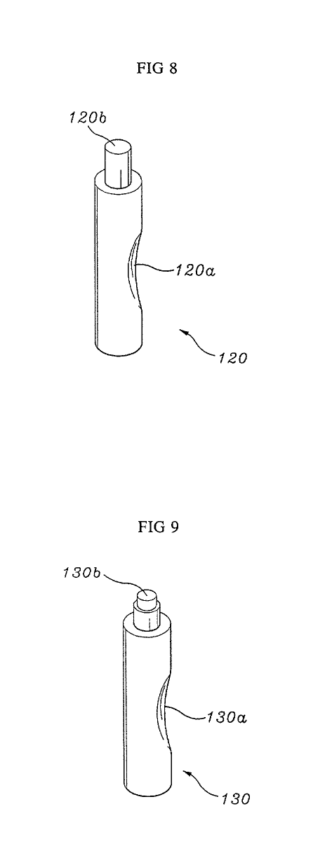

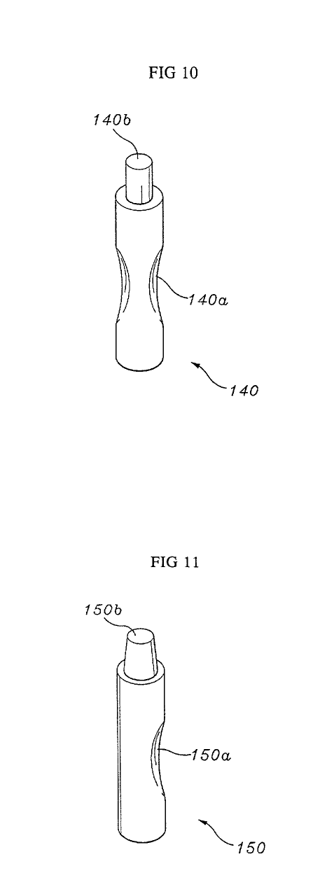

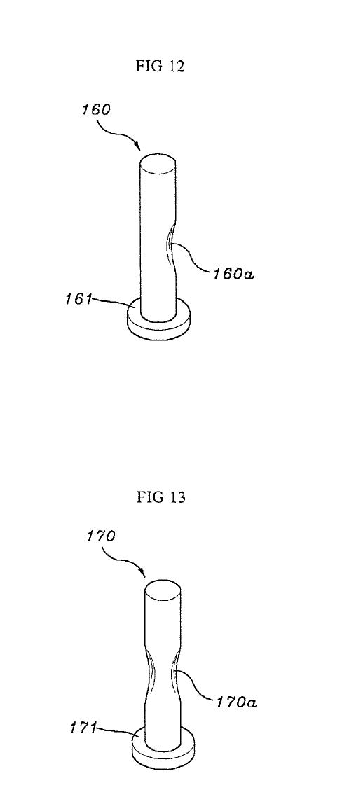

FIG. 5 is a cross-sectional view for showing the state in which a gas opening/closing pin according to the present invention interrupts a gas inlet and outlet of a pipe holder, and FIG. 6 is a cross-sectional view for showing the state in which a gas opening/closing pin according to the present invention opens the gas inlet and outlet of the pipe holder, and FIGS. 7 to 13 is a perspective view for showing various preferred embodiments of gas opening/closing pins according to the present invention.

Gas opening/closing pins 100, 110, 120, 130, 140, 150, 160, and 170 has a predetermined diameter as shown in FIGS. 5 to 13. The gas opening/closing pins is assembled from the lower portion of the pipe holder 70′. At least one recess 100a, 110a, 120a, 130a, 140a, 150a, 160a, and 170a is formed at the central portion so that a first chamber 30a which is the upper portion of a piston 11 is communicated with a gas inlet and outlet 16 of the pipe holder 70′ in case the gas opening/closing pin is moved downward.

An annular jaw 70a′ is formed at the inlet of the upper side of a hole 41 of the pipe holder 70′ so that the gas opening/closing pin is not pushed by the gas pressure of the first chamber 30a and deviated from the hole 41 of the pipe holder 70′. A diameter reducing portion 100b, 110b, 120b, 130b, 140b, 150b in which the diameter is reduced is formed at the upper end portion of the gas opening/closing pin and the diameter reducing portion is caught by the annular jaw 70a′ of the pipe holder 70′, or a washer-shaped boss body 161 and 171 is integrally formed at the lower end portion of the gas opening/closing pin as shown in FIGS. 12 and 13 and the boss body is caught by the lower portion of the pipe holder.

In case the washer-shaped boss body is formed, the diameter reducing portion does not need to be formed a the upper end portion of the gas opening/closing pin and the annular jaw does not need to be formed in the pipe holder.

Since the diameter reducing portion 100b, 110b, 120b, 130b, 140b, and 150b is caught by the annular jaw 70a′ or the washer-shaped boss body 161 and 171 is caught by the lower portion of the pipe holder even when the pressure which pushes the gas opening/closing pin 100, 110, 120, 130, 140, 150, 160, and 170 upward is applied to the gas opening/closing pin by the pressure of the first chamber 30a, the gas opening/closing pin is not deviated from the hole 41 of the pipe holder 70′.

It is preferable that the outer periphery of the upper end portion of the diameter reducing portion is curved by chamfering.

FIGS. 5 and 6 are views for showing the opening/closing operation of the gas opening/closing pin 100, and FIG. 5 shows the state in which the force is not applied to the gas opening/closing pin 100. Here, the diameter reducing portion 100b is caught by the annular jaw 70a′, and the lower portion of the gas opening/closing pin 100 closes the hole 70a of the pipe holder 70′ together with the O-ring 45 and thus the gas inlet and outlet 16 is closed. FIG. 6 is a view for showing the state in which a force which presses the gas opening/closing pin 100 downward is applied to the gas opening/closing pin, and the diameter reducing portion 100b is not caught by the annular jaw 70a′ and is moved downward, and a recess 100a of the gas opening/closing pin 100 is located at a height of the O-ring 45, and thus the first chamber 30a is communicated with the gas inlet and outlet 16 of the pipe holder 70′.

FIG. 7 is a perspective view for showing another structure of the gas opening/closing pin 110, a diameter reducing portion 10b which has two steps is formed at the upper portion, and an annular recess 110a is formed at the central portion.

Other structure of the gas opening/closing pin according to the present invention is shown in FIGS. 8 to 13.

In FIG. 8, a diameter reducing portion 120b which has one step is formed at the upper portion of the gas opening/closing pin 120 and a recess 120a is formed on one side of the central portion. In FIG. 9, a diameter reducing portion 130b which has two steps is formed at the upper portion of the gas opening/closing pin 130 and a recess 130a is formed on one side of the central portion. In FIG. 10, a diameter reducing portion 140b which has one step is formed a t the upper portion of the gas opening/closing pin 140, and two recesses 140a are symmetrically formed.

In FIG. 11, a recess 150a is formed on one side of the central portion of the gas opening/closing pin 150, and a diameter reducing portion 150b which has one step is formed at the upper portion of the gas opening/closing pin, and the diameter reducing portion 150b is tapered and the diameter of the upper portion is smaller than that of the lower portion. In the case the annular jaw 70a′ of the pipe holder 70′ can be stepped as shown in FIGS. 5 and 6 and the diameter can be smoothly reduced.

At least one streamline shaped recess 160a and 170a can be formed at the central portion of the gas opening/closing pin as shown in FIGS. 12 and 13, and a washer-shaped boss body 161 and 171 which is integrally formed with the gas opening/closing pin can be formed at the lower portion.

In case the washer-shaped boss body is formed, the diameter reducing portion does not need to be formed at the upper portion of the gas opening/closing pin, and thus the annular jaw of the pipe holder catching the diameter reducing portion does not need to be installed.

A streamline shaped recess or an annular recess can be formed in the gas opening/closing pin, but the number of the recesses does not need to be restricted in case the streamline shaped recess is installed.

The gas opening/closing pin 100, 110, 120, 130, 140, 150, 160, and 170 can be made of a metal or a nonmetal. In case the gas opening/closing pin is made of a metal, it is preferable that it is manufactured by cooling forging.

According to the gas opening/closing pin of the present invention, since the diameter reducing portion is formed in the gas opening/closing pin and the jaw catching the diameter reducing portion is formed at the inlet of the upper portion of the hole of the pipe holder or the washer-shaped boss body is integrally formed with the lower portion of the gas opening/closing pin without forming the diameter reducing portion of the gas opening/closing pin and the annular jaw of the pipe holder, the assembling process is simple. Further, since a separate washer is not needed, the manufacturing cost is reduced.

As stated above, preferred embodiments of the present invention are shown and described. Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A gas opening/closing pin which opens and closes a gas inlet and outlet formed in a pipe holder which seals one end portion of a cylinder and moves the position of a piston in the cylinder, wherein at least one recess which opens the gas inlet and outlet is formed on the outer peripheral surface of the central portion of the gas opening/closing pin and one of a washer-shaped boss body and a diameter reducing portion in which the diameter is reduced is integrally formed.

2. A gas opening/closing pin according to claim 1, wherein the lower end portion of the diameter reducing portion of the gas opening/closing pin is caught by an annular jaw corresponding to the diameter reducing portion of the gas opening/closing pin and installed in the pipe holder.

3. A gas opening/closing pin according to claim 2, wherein the diameter reducing portion has at least one step.

4. A gas opening/closing pin according to claim 2, wherein the diameter reducing portion is tapered.

5. A gas opening/closing pin according to one of claims 1 to 4, wherein the gas opening/closing pin is made of a metal.

6. A gas opening/closing pin according to one of claims 1 to 4, wherein the outer periphery of the upper end portion of the gas opening/closing pin is chamfered..

7. A gas opening/closing pin according to one of claims 1 to 4, wherein the gas opening/closing pin is made of a nonmetal.

8. A gas opening/closing pin according to claim 1, wherein the recess formed on the outer peripheral surface of the central portion of the gas opening/closing pin is streamline-shaped.

9. A gas opening/closing pin according to claim 1, wherein the recess formed on the outer peripheral surface of the central portion of the gas opening/closing pin has an annular shape.
